(19) United States
(12) Patent Application Publication
(10) Pub. No.: US 2010/0047553 A1
(43) Pub. Date: Feb. 25, 2010

(54) Coating Reinforcement Apparatus and Method

(76) Inventor: Jon H. Brasher, Opelika, AL (US)

Correspondence Address: LANIER FORD SHAVER & PAYNE P.C., P O BOX 2087, HUNTSVILLE, AL, 35804-2087, US

(21) Appl. No.: 12/543,978

(22) Filed: Aug. 19, 2009

Related U.S. Application Data
(60) Provisional application No. 61/090,592, filed on Aug. 20, 2008.

(51) Int. Cl. B32B 3/26; B32B 37/14

(52) U.S. Cl. 428/320.2; 156/256

(57) ABSTRACT

An apparatus of the present disclosure comprises a substrate having a first and second surface and an aperture formed in the substrate that extends from the first surface to the second surface of the substrate. In addition, the apparatus comprises a polymer-type coating formed on the first surface and a polymer-type coating formed on the second surface, the polymer-type coating formed on the first surface extending through the aperture and the polymer-type coating formed on the second surface extending through the aperture thereby connecting the polymer-type coating formed on the first surface with the polymer-type coating formed on the second surface.

### CROSS-REFERENCE TO RELATED APPLICATIONS

This application claims priority to Provisional Patent Application Ser. No. 61/090,592, entitled “Process For Applying A Polymer Coating To—And Enclosing—A Substrate That Has Been Perforated With Either a Random Or An Ordered Pattern Of Holes,” filed on Aug. 20, 2008, which is incorporated herein by reference.

### BACKGROUND

Many objects are used outdoors to serve a variety of functions. Outdoor objects may be made from numerous materials, for example, they may consist of plastics or metals. The outdoor objects are exposed on a day-to-day basis to changing and sometimes harsh weather conditions and/or other external anomalies.

Without some type of protection, the outdoor objects can rapidly deteriorate. Therefore, oftentimes these outdoor objects are coated with some type material that tends to protect them from the harsh weather conditions and/or other external anomalies. However, the coating that is placed on the objects oftentimes, over time, tends to crack and peel away from the outdoor object.

### SUMMARY

An apparatus in accordance with an embodiment of the present disclosure comprises a substrate having a first and second surface and an aperture formed in the substrate that extends from the first surface to the second surface of the substrate. In addition, the apparatus comprises a polymer-type coating formed on the first surface and a polymer-type coating formed on the second surface, the polymer-type coating formed on the first surface extending through the aperture and the polymer-type coating formed on the second surface extending through the aperture thereby connecting the polymer-type coating formed on the first surface with the polymer-type coating formed on the second surface.

A method in accordance with an embodiment of the present disclosure comprises creating at least one aperture in a substrate and applying a polymer-type coating to a first and second surface of the substrate, and the polymer type coating fills the aperture thereby connecting polymer-type coating on the first surface to the polymer-type coating on the second surface. The method further comprises curing the coating.

### DESCRIPTION OF THE DRAWING FIGURES

FIG. 1 is a perspective view of an exemplary substrate having a plurality of apertures in accordance with an embodiment of the present disclosure.

FIG. 2 is a perspective view of the substrate of FIG. 1 further having coatings adhered to two surfaces of the substrate.

FIG. 3 is a top plan view of the coating adhered to the substrate as depicted in FIG. 2.

FIG. 4 is a cross-sectional view of the substrate and the coatings taken along line A-A′ of FIG. 3.

FIG. 5 is a top plan view of an exemplary substrate in accordance with another embodiment of the present disclosure.

FIG. 6 is a perspective view of an exemplary pole having a plurality of apertures in accordance with an embodiment of the present disclosure.

FIG. 7 is a perspective view of the pole of FIG. 5 further having coatings adhered to an inside surface and an outside surface of the pole.

FIG. 8 is a cross-section view of the pole and the coatings taken along line B-B′ of FIG. 6.

FIG. 9 is a flowchart of an exemplary method in accordance with an embodiment of the present disclosure.

### DETAILED DESCRIPTION

The present disclosure generally relates to coating reinforcement systems and methods. In particular, the present disclosure relates to a system whereby a structure is protected from environmental conditions, such as, for example harsh weather conditions, by applying a coating, such as, for example, a polymer-type material, to both surfaces of the structure.

In accordance with the present disclosure, the coating is reinforced by the perforation of the structure, i.e., one creates apertures in the structure that extend from one surface of the structure to the other. The coating adheres to both surfaces of the structure, and also fills the apertures thereby reinforcing the polymer coating after it hardens and adheres to the surface of the structure and hardens and adheres within the apertures. The coating that fills the apertures reinforces the coating on the surfaces so that the coating will not flake or peel away from the surface of the structure as a result of wear or harsh weather conditions.

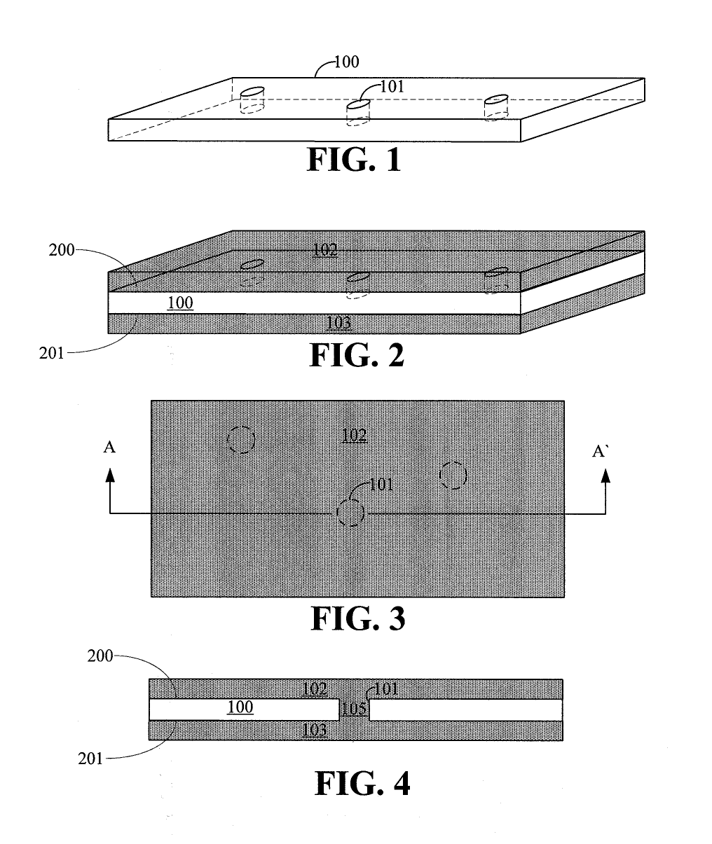

FIG. 1 depicts an exemplary substrate 100 in accordance with an embodiment of the present disclosure. The substrate 100 may comprise any type of material, including metallic, plastic, or fiberglass material. Notably, the substrate 100 may comprise other types of materials known in the art or future-developed. Within the substrate 100 are a plurality of apertures 101 that extend completely through the substrate 100.

The number, size, and shape of the apertures may vary depending upon the application. Thus, while three circular apertures 101 are shown in FIG. 1, this is for exemplary purposes only.

In one embodiment, the aperture 101 has a diameter that is substantially equal to the thickness of the substrate 100. In such an embodiment, there is a direct relationship between the thickness of the substrate 100 and the desired diameter of the aperture 101.

Note that the apertures may be formed in the structure using any type of process known or future-developed, including, but not limited to drilling, punching, stamping, or any other method for generating the apertures 101. Further note that the apertures 101 may be in a random or ordered pattern in the substrate, which is described further herein. The pattern shown in FIG. 1 is a random pattern of three apertures.

FIG. 2 depicts the substrate 100 having a coating 102 on a first surface 200 of the substrate 100, and a coating 103 on a second surface 201 of the substrate 100. In one embodiment, the coatings 102, 103 consist of a polymer-type material, however, other types of materials may be used in other embodiments for protecting the substrate 100 from, for example, weather elements.

Note that in one embodiment, the substrate 100 is treated before the coatings 102, 103 are applied to the substrate 100. If the substrate 100 comprises, for example, a metallic material, then it may be desirable to galvanize the surfaces 200, 201 of the substrate 100 or cover the surfaces 200, 201 of the substrate 100 with a primer (not shown), for example, before applying the coatings 102, 103. Galvanization or priming ensures that the coatings 102, 103 stick to the surfaces 200, 201 of the substrate 100.

If the substrate 100 comprises, for example, plastic or fiberglass, it may be desirable to prime or etch the surfaces 200, 201 of the substrate 100. Priming or etching the surfaces 200, 201 of the substrate 100 ensures that the coatings 102, 103 stick to the surfaces 200, 201 of the substrate 100.

In one embodiment, the coatings 102, 103 can be applied through a heating process. In this regard, the substrate 100 is heated to a desired temperature of approximately 315° Fahrenheit (F). Note that 315° F. is provided as an exemplary desired temperature, and other temperatures may be used in other embodiments.

The polymer-type material is then applied to a specified thickness. Notably, the thickness to which the polymer-type material is applied varies depending upon the application of the coatings 102, 103. The polymer-type material is applied by immersing the substrate 100 in the polymer-type material or by wrapping a layer of raw polymer-type material about the heated substrate 100.

When the polymer-type material contacts the heated substrate 100, it melts and adheres to the substrate 100. As it melts to the substrate 100, portions of the polymer-type material form the coatings 102, 103 and portions pass through the apertures 101 thereby linking the coatings 102, 103 one to the other. In one embodiment, the temperature of the substrate 100 is maintained for twenty minutes to cure the coatings 102, 103.

The temperature of the substrate 100 may be maintained in a number of ways. As an example, in one embodiment, the temperature of the substrate 100 may be maintained by convection. In this regard, hot air may be blown over the substrate 100 to bring the substrate 100 to the desired temperature and maintain the temperature prior to coating and during coating of the substrate 100 until the substrate 100 is cured.

In another embodiment, the substrate 100 may be placed in an oven to reach the desired temperature. Once the substrate reaches the desired temperature, the substrate 100 may then be removed from the oven, immersed in the polymer-type material, then placed back into the oven until the coatings 102,103 of the polymer-type material cure.

In another embodiment, a positive charge may be applied to the substrate 100. The positive charge induces a current in the substrate 100 that causes the substrate 100 to heat to the desired temperature. The polymer-type material is then applied to the substrate 100 when it reaches the desired temperature, and the current continues to flow through the substrate 100 until curing occurs forming the coatings 102, 103.

In another embodiment, raw polymer-type material may be applied to the substrate within a vacuum chamber. The vacuum causes the raw polymer-type material to conform to the substrate and a portion of the raw polymer-type material to pass through the apertures 101. Thus, the coatings 102, 103 are formed. To cure, heat is applied within the vacuum chamber at the desired temperature in order to cure the coatings 102, 103.

FIG. 3 is a top plan view of FIG. 2 showing the coating 102 in relation to the apertures 101. FIG. 4 is a cross-sectional view of FIG. 3 taken along line A-A′ of FIG. 3. Notably, when the coating 102 is applied to the surface 200 of the substrate 100, and the coating 103 is applied to the surface 201 of the substrate 100, a portion of the coating 105 fills the aperture 101, thereby supporting and reinforcing the coating 102, 103 that adheres to the substrate 100. In this regard, the coating 105 connects the coating 102 to the coating 103, thereby supporting and reinforcing the coatings 102, 103. Such support reduces cracking, chipping, and peeling that may result from harsh weather, for example.

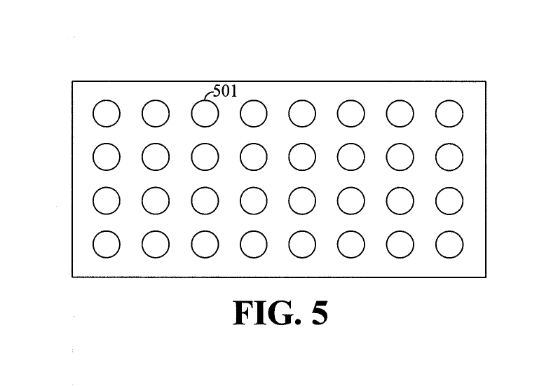

FIG. 5 depicts a top plan view of a substrate 500 in accordance with another embodiment of the present disclosure. Substrate 500 differs from the substrate 100 (FIG. 1) in that a plurality of apertures 501 are created in the substrate 500 in an ordered pattern, i.e., in rows and columns. In contrast, the apertures 101 (FIG. 1) are randomly created in the substrate 101.

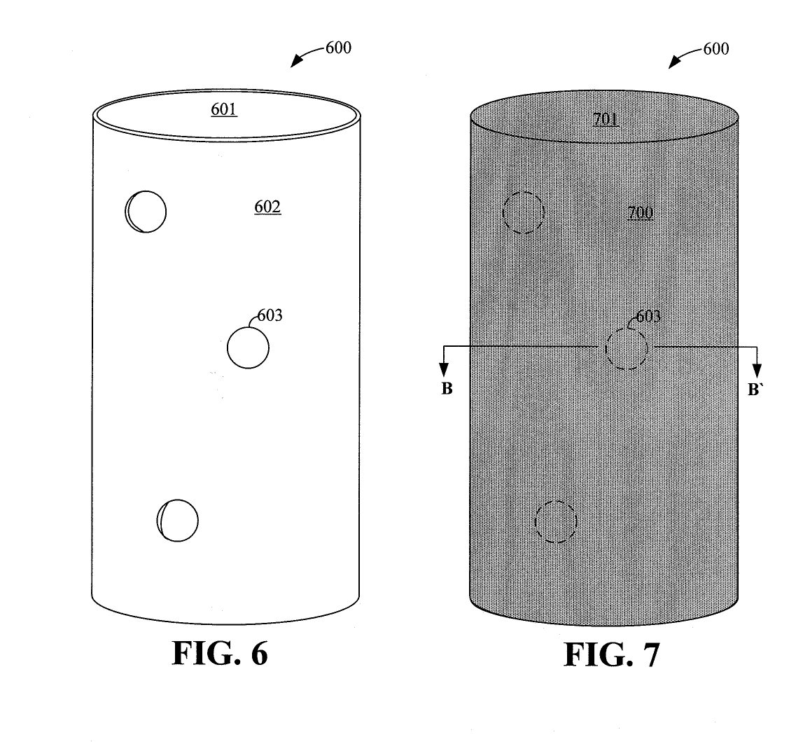

FIGS. 6-8 as described illustrate one application of the present disclosure. In this regard, FIG. 6 depicts a pole 600, such as, for example, an outdoor lighting pole. The pole 600 comprises a hollow cylinder with an inside surface 601 and an outside surface 602. In addition, the pole 600 comprises a plurality of apertures 603 that extend from the outside surface 602 to the inside surface 601.

FIG. 7 depicts the pole 600 having a coating 700 on its outside surface 602 (FIG. 6) and a coating 701 on its inside surface 601 (FIG. 6). In one embodiment, the coatings 700, 701 comprise a polymer-type material; however, other types of materials may be used in other embodiments for protecting the pole 600 from weather elements, for example.

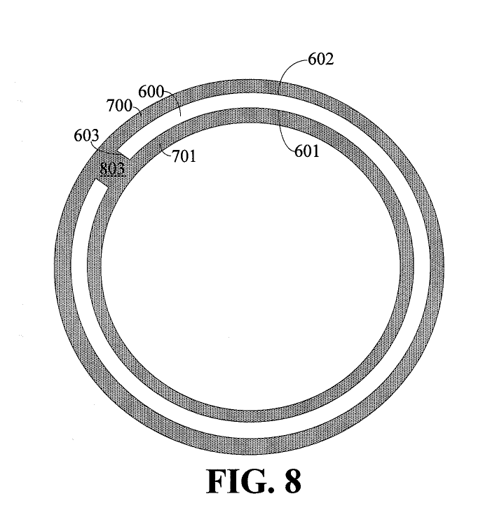

FIG. 8 is a cross-sectional view of FIG. 7 taken along line B-B′. When the coating 701 is applied to the inside surface 601 of the pole 600 and the coating 700 is applied to the outside surface 602 of the pole 600, coating 803 fills the aperture 603, thereby supporting and reinforcing the coating 700, 701 that adheres to the pole 600. In this regard, the coating 803 connects the coating 700 to the coating 701. Such support reduces cracking, chipping, and peeling that may result from harsh weather, for example.

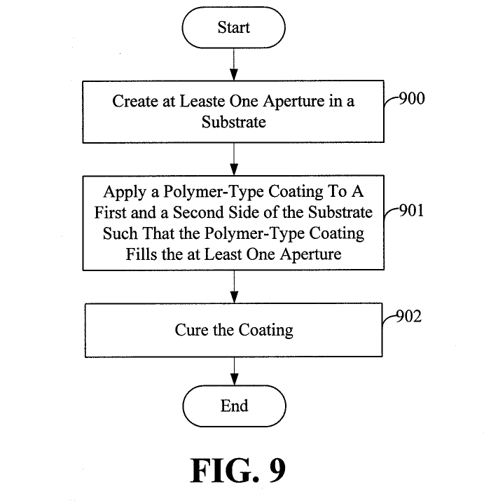

FIG. 9 is a flowchart depicting an exemplary method in accordance with an embodiment of the present disclosure. In step 900, at least one aperture 101 (FIG. 1) is formed in a substrate 100 (FIG. 1). As described hereinabove, the substrate 100 may be a metal-like or plastic-like material. In addition, one aperture 101 or a plurality of apertures 101 may be formed randomly or in a pattern within the substrate 100 by drilling, punching, stamping or by another other method known in the art or future-developed.

In step 901, a polymer-type material is applied to a first and a second surface of the substrate 100 such that the polymer-type material forms coatings 102, 103 (FIG. 2) and fills the at least one aperture 101. In step 902, the coatings 102, 103 are cured. Such curing and application of the polymer-type material may be accomplished in any manner known in the art or future-developed.

As described hereinabove, the substrate 100 may be heated by convection and the substrate 100 coated with the polymer-type material. In addition, the substrate 100 may be placed in an oven, heated, the polymer-type material placed on the substrate 100, and the substrate 100 placed back in the oven. Further, electrical current may be used to heat the substrate 100 before the polymer-type material is applied or the polymer-type material may be cured in a pressurized vacuum, as described hereinabove.

What is claimed is:

1. An apparatus, comprising:
a substrate having a first and second surface;
an aperture formed in the substrate that extends from the first surface to the second surface of the substrate; and
a polymer-type coating formed on the first surface and a polymer-type coating formed on the second surface, the polymer-type coating formed on the first surface extending through the aperture and the polymer-type coating formed on the second surface extending through the aperture thereby connecting the polymer-type coating formed on the first surface with the polymer-type coating formed on the second surface.

2. The apparatus of claim 1, wherein the apparatus further comprises a plurality of apertures.

3. The apparatus of claim 2, wherein the plurality of apertures in the substrate are randomly formed.

4. The apparatus of claim 3, wherein the plurality of apertures in the substrate form an ordered pattern.

5. The apparatus of claim 1, wherein the aperture has a diameter that is substantially equal to the thickness of the substrate.

6. The apparatus of claim 1, wherein the substrate is galvanized metal.

7. The apparatus of claim 1, wherein the substrate is coated with a primer on the first and second surfaces and the polymer-type coating is formed on top of the primer.

8. A method, comprising:
creating at least one aperture in a substrate;
applying a polymer-type coating to a first and second surface of the substrate, such that the polymer type coating fills the aperture thereby connecting polymer-type coating on the first surface to the polymer-type coating on the second surface; and
curing the coating.

9. The method of claim 8, wherein the creating step further comprises drilling the aperture in the substrate.

10. The method of claim 8, wherein the creating step further comprises punching the aperture in the substrate.

11. The method of claim 8, wherein the creating step further comprises stamping the aperture in the substrate.

12. The method of claim 9, wherein the creating step further comprises creating a plurality of apertures in the substrate.

13. The method of claim 12, wherein the creating step further comprises creating the plurality of apertures in a random formation on the substrate.

14. The method of claim 12, wherein the creating step further comprises creating the plurality of apertures in the substrate in an ordered pattern.

15. The method of claim 8, wherein the creation step further comprises creating the aperture with a diameter that is substantially equal to the thickness of the substrate.

16. The method of claim 8, wherein the substrate is metallic, and the applying step further comprises galvanizing the substrate before applying the polymer-type coatings to the substrate.

17. The method of claim 8, wherein the substrate is plastic or fiberglass, and the applying step further comprises applying a primer to the substrate before applying the polymer-type coatings to the substrate.

18. The method of claim 8, wherein the substrate is plastic or fiberglass, and the applying step further comprises applying etching the substrate before applying the polymer-type coatings to the substrate.

19. The method of claim 8, further comprising the step of heating the substrate and wherein the applying step further comprises applying the polymer-type coatings to the heated substrate.

20. The method of claim 19, further comprising continuing to heat the substrate during the curing step.
